(19) United States
(12) Patent Application Publication
(10) Pub. No.: US 2026/0233977 A1
(43) Pub. Date: Aug. 13, 2026

(54) METHOD AND SYSTEM FOR COMPENSATING MOTION OF A SUSPENDED OBJECT

(71) Applicant: DELTA LABORATORIES HOLDING B.V., Rotterdam (NL)

(72) Inventors: André SCHIELE, Rotterdam (NL); Dabian OOSTERLOO, Rotterdam (NL); Bas VAN OORSCHOT, Rotterdam (NL)

(21) Appl. No.: 19/474,738

(22) PCT Filed: Apr. 10, 2024
(86) PCT No.: PCT/NL2024/050182

§ 371 Date: Oct. 13, 2025

(30) Foreign Application Priority Data
Apr. 11, 2023 (NL) 2034539

(51) Int. Cl. B66C 13/08; B66C 23/52; B66D 1/52

(52) U.S. Cl. CPC B66C 13/085; B66C 23/52; B66D 1/525

(57) ABSTRACT

A method and system for compensating motion of an object (24) suspended from a hoisting arrangement (16) that is moveably mounted on a vessel (10) associated with a target reference frame and moving relative to an external reference frame. The system includes winches (38) connected to the vessel and taglines (39) interconnecting the winches (38) with the object to exert tensional forces. The system includes a pose sensor (45) for measuring a pose (82) of the object, and a control device (50) for actuating the winches to adjust the tagline lengths, for calculating a target pose with non-zero offset for the object relative to the target reference frame, and for dynamically actuating (75) the winches to adjust the tagline lengths to let the object assume the target pose while the vessel moves relative to the external reference frame, based on an error determined between the target pose and the momentary pose of the object.

### TECHNICAL FIELD

The invention relates to a method for compensating swinging motion of an object suspended from a hoisting arrangement that is moveably mounted in/on a vessel or other moving platform, and to a system configured to execute such a method. Furthermore, the invention relates to a computer program product configured to perform the proposed method, and a computer readable medium comprising such a computer program.

### BACKGROUND ART

The deployment of offshore wind turbine generators initially may require monopile foundations to be installed onto the seafloor. When a turbine generator is to be situated remotely from the coastline, the installation of the monopile foundation is typically carried out by a construction vessel with a hoisting arrangement such as a deck-mounted crane. Known deployment scenarios involve the use of a so-called “jack-up vessel”, which is provided with extendable support legs that allow the vessel to be temporarily immobilized relative to the seafloor. A more challenging placement scenario involves manipulation of the monopiles while the vessel remains floating and subjected to wave and wind influences while relying on motion compensation capabilities.

FIGS. 1a-1b show a vessel 10, which is configured to drive a monopile 26 into a submerged surface, such as a seafloor, which forms a water-soil interface between a body of water 11 (e.g. a sea) and a portion of the earth below. The exemplary vessel 10 is configured to carry monopiles 26a-c to their intended installation site located offshore. The vessel 10 comprises a deck 12 that is adapted for supporting several monopiles 26. In the example shown in FIGS. 1a-1b, the vessel 10 is adapted to carry the monopiles 26 in a mutually parallel arranged manner, in which the piles extend horizontally in lateral direction across the deck 12.

The exemplary vessel 10 is further provided with a hoisting arrangement 16-22 for lifting and moving a monopile 26a, as well as an additional frame 28 for pivoting and guiding the monopile 26a when lowering it into the water. In the shown example, the hoisting arrangement is formed by a jib crane 16, which comprises a pedestal 17, a turret 18, and an arm 19. The pedestal 17 is fixed in an upright position to the deck 12. The turret 18 is rotatably fixed to the pedestal 17, to allow the turret to pivot sideways (“slew”) about a nominal vertical slewing axis As relative to the deck 12. The arm 19 is rotatably fixed to the turret 18 to allow the arm 19 to pivot up/downwards (“luff”) about a nominal luffing axis Al relative to the turret 18.

The crane 16 is further provided with a hoist line 20, having a free lower distal end from which a rider block 21 and a hook 22 are suspended. The monopile 26a can be attached to the hoist line 20 and the rider block 21 via the hook 22 and a specifically designed tool 24 that will be explained with reference to FIGS. 2a-2b. Before it can be placed on and driven into the seafloor, the monopile 26a must be lifted by the crane 16 from the substantially horizontal position across the deck 12 (FIG. 1a) into a suspended substantially vertical position (FIG. 1b). This lifting is also referred to as “up-ending”. The upending operation requires the use of the engagement tool 24, which is suspended at the distal end of the hoist line 20. This tool 24 is commonly referred to as “upending tool”. Before the monopile 26 can be lifted from the deck 12, the tool 24 first needs to be inserted into the opening 27 that is formed at a distal (upper) end of the monopile 26, while the monopile 26 lies horizontally on the deck 12. As monopiles 26 are often provided with a circular mounting flange at the upper opening 27, the upending tool 24 may also be referred to as a “flanged pile upending tool (FPUT)” or “flanged monopile upending tool (FMUT)”. Once inserted, the tool 24 needs to firmly clamp or latch on to the monopile 26. This engaging and gripping of the pile 26 by the tool 24 is also referred to as “stabbing”. Stabbing requires careful manoeuvring with the hoisting arrangement 16-22.

After a successful stabbing operation, the crane 16 may actuate the hoist line 20 to lift the tool 24 and monopile 26a upwards from the deck 12. The crane 16 may subsequently actuate the turret 18 together with the arm 19 to slew the turret 18 and the arm 19 with the suspended monopile 26 above the deck 12, while also luffing the arm 19 up and down to move the suspended monopile 26 closer to and away from the slew axis As. Successful upending allows the crane 16 to place the monopile 26 next to the vessel 10 via the pivoting frame 28 into the vertical orientation as shown in FIG. 1b. From this position, the monopile 26 may be lowered into the water until it rests with its lower distal end on the seafloor. The monopile 26 can then be driven up to the intended insertion depth into the seafloor by a pile driver, so that it can form the foundation for the wind turbine generator.

Patent document WO2021/180515A1 describes an example of an upending tool, which is repositionable between horizontal and vertical orientations and has a cable shifting mechanism for inducing the transition, and which may be used for stabbing and upending of a monopile.

When performing a stabbing operation on land, the tool can be placed on the ground at a location corresponding to a static reference system of the pile. In this case, the tool can be easily moved and aligned with the horizontally arranged pile, for instance by placing the tool on a cart that is moveable in horizontal and vertical directions to align the tool with the pile opening. In such ground-based settings, human operators can remain near the tool to supervise fine-alignment between the tool and the pile.

By contrast, the aligning and stabbing are extremely challenging from a moving vessel. Manoeuvring and stabbing are hampered by wind-loads and wave-induced motion of the floating vessel 10, as the vessel 10 is subject to motion in six degrees of freedom, including three translational directions and three rotational directions. In a Cartesian reference frame {Cv} associated with the vessel 10, an Xv-axis extends parallel with the longitudinal direction of the vessel 10, a Yv-axis extends parallel with a transverse direction of the vessel 10, and a Zv-axis extends perpendicularly to a deck 12 of the vessel 10. As the vessel 10 may move relative to the surrounding body of water 11, a spatial relation between vessel reference frame {Cv} and a fixed external reference frame {Ce} associated with the earth is expected to be different at different moments in time. Translations of the vessel 10 in the Xv-, Yv-, and Zv-directions are referred to as “surge”, “sway”, and “heave”, respectively. Rotations of the vessel 10 about the Xv-, Yv-, and Zv-axes are referred to as “roll”, “pitch”, and “yaw”, respectively. All these motional degrees of freedom may result in complicated swinging of an object that is suspended from the hoisting arrangement 16-22, as the arrangement is connected to the vessel deck 12 and is thus bound to follow the vessel movements.

The tool 24 can be associated with a local reference frame {Co} with corresponding Cartesian axes Xo, Yo and Zo. This local frame {Co} generally differs from the vessel reference frame {Cv}. Once the tool 24 is suspended from the crane 16, the spatial relations between the vessel reference frame {Cv}, the fixed external reference frame {Ce}, and the tool reference frame {Co} are expected to change continuously. The suspended tool 24 can be subject to large and unpredictable swinging motions in multiple directions relative to the vessel 10 and the body of water 11 (and seafloor). Except from the vertical Zo-direction, the suspended tool 24 may swing in any of the remaining degrees of freedom. For instance, it could translate in both horizontal translational Xo- and Yo-directions and at the same time rotate around any/all of its three axes, thus exhibiting a complex swinging motion.

During stabbing, the tool 24 need to be aligned with the pile 26. Stabbing typically needs to adhere to strict geometrical and mechanical tolerances. Excessive swinging may cause uncontrolled collisions and impact loads (“bump-loads”) between the tool 24 and the pile 26. Such loads are not allowed to exceed strict pre-defined tolerances, to prevent damage to the structure and/or protective coating of the pile 26 (or the tool 24). If swinging motions of the suspended tool 24 are larger than the permitted tolerances, then a stabbing operation can lead to damage, or may not be allowed to be performed and then must be postponed.

When piles 26 are stored laterally on the vessel 10 (i.e. in a port-starboard direction at a 90°-angle relative to the vessel hull), fine alignment between the tool 24 and the opening 27 of the pile 26 needs to take place far outside the perimeter of the deck 12, at a location that is difficult to reach by human operators. Even when piles 26 are stored longitudinally in the bow-stern-direction along the deck 12, the piles 26 may stick out beyond the bow or stern. In all cases, stabbing of the pile 26 with the upending tool 24 in an offshore setting is challenging when external factors cause considerable motions of the vessel 10, the pile 26, the crane 16 and the suspended stabbing tool 24.

Patent document WO2022/096523A1 describes a protruding on-deck structure for mitigating swinging of the upending tool suspended from a moving construction ship. Although this protruding structure assists in aligning the stabling tool with the pile opening to prepare for stabbing, the structure is bulky and requires excessive deck-space.

It would be desirable to provide a system and method that allow safe and reliable tool alignment and stabbing of a monopile from within a moving reference frame, such as an offshore setting, without the need of a bulky structure.

### SUMMARY OF INVENTION

Therefore, according to a first aspect, there is provided a system for compensating motion of an object suspended from a hoisting arrangement that is moveably mounted in/on a vessel or other moving platform. The vessel or platform is associated with a target reference frame and is allowed to move relative to a fixed external reference frame, which may for instance be an earth-fixed reference frame. The vessel includes winches that may be connected to the vessel, for instance mechanically connected directly to the vessel so that the respective winch positions are fixed relative to the vessel deck, or moveably connected to allow repositioning relative to the vessel (e.g. along the deck). The winches are coupled to respective taglines. Each tagline interconnects a respective winch with a corresponding attachment portion on the object, to allow exerting a tensional force between the winch and the object. The system includes a pose sensor and a control device. The pose sensor may be configured to measure a momentary pose of the object relative to the target reference frame. The control device may be configured to independently actuate the winches, to adjust a length of the corresponding tagline and thereby change the tensional force. The control device may further be configured to calculate a target pose for the object relative to the target reference frame. This momentary target pose may include an offset relative to an initial pose that the object would assume when suspended from the hoisting arrangement but without the presence and force of the taglines. The offset may include non-zero lateral displacements directed along respective taglines and towards corresponding winches. The control device may be configured to calculate the target pose in a dynamic fashion, in that the control device updates the calculated parameters for the target pose on the fly in response to received sensor reading updates. The offset may also be calculated as a momentary offset, or may be a fixed offset that has been calculated or otherwise supplied in advance. The control device may further be configured to dynamically actuate the winches to adjust lengths of the respective taglines to let the object assume and maintain the target pose while the vessel moves relative to the external reference frame. The calculations of the desired tension distributions for actuating the winches may be based on an error determined between the target pose and the momentary pose of the object.

The proposed system allows creating a determined pre-load, which can be either created dynamically or pre-defined, between the hoisting arrangement (e.g. crane), the suspended object, the winches with taglines, such that the pose of the suspended object can be given an offset and thereby be controlled in substantially different directions than only those pulling directions that the winches by themselves would allow (since flexible cables/lines cannot convey pushing forces).

Term “position” is used herein to refer to a three-dimensional set of coordinates or translation vector relative to a given coordinate reference frame. The position of an object—or a representative point for this object like its centre of mass—may be represented in 3D space by a vector in [symbol] ³. The term “orientation” is used herein to refer to the three-dimensional rotational state of the object around predefined axis, which may either be expressed relative to the object's own local reference frame or relative to an external reference frame. The orientation of an object may be represented in 3D space by orthonormal rotation matrices, Euler angles, roll-pitch-yaw angles, unit-quaternions, or matrix exponentials. The combination of the position and the orientation of an object is referred to herein as the “pose” of the object.

The target reference frame may be associated with the vessel (e.g. a fixed position on the vessel deck) and for which a spatial relation with the vessel reference frame is fixed and known. The pose sensor may be configured to measure the object's momentary pose directly with respect to the target reference frame, for instance by being mounted at a fixed and known position within this target reference frame. Alternatively, the sensor may be configured to measure the object's momentary pose directly in a fixed reference frame, which may then be related to the target reference frame by an additionally computed coordinate transformation.

The term “line” (as e.g. in “hoist line” and “tagline”) is used herein to refer generally to any kind of elongated connection like a wire, cable, chain, rope, cord, etc (or any plurality or combination thereof) and is assumed to be sufficiently strong to lift a load connected thereto and/or for controlling the pose of that load. The term “tagline” is used herein to refer to an elongate connection between a winch and a load, configured to exert a pulling force between this winch and load. The tagline may be structurally composed of a single continuous line, a group of parallel lines, and/or a series of interconnected line segments. Irrespective of this structure, the tagline is assumed to have a certain flexibility that renders it unsuitable to exert a pushing force. The phrase “connected to the load‘ may—but does not necessarily—mean that the end of the tagline is rigidly fixed to the load. Alternatively, the tagline may be passed through a sheave connected to the load and then passed back to its original attachment point (e.g. the vessel). The term “winch” is used to refer to any machine or instrument for hauling or pulling, and includes a drum or spool from/on which a line may be (un)wound by means of a rotational actuator, possibly powered by e.g. an electric, pneumatic, hydraulic, or combustion drive.

According to an embodiment, the system may further include force sensors associated with respective taglines. Each such force sensor may be configured to measure an indication of a momentary tensile force acting in or on the corresponding tagline. The control device may be in signal connection with the force sensors and may be configured to dynamically actuate the winches based on the momentary tensile forces measured by the sensors, as well as based on the instantaneous error determined between the target pose and the measured momentary pose of the object.

Dynamically measuring the momentary tensile forces in the taglines allows a quicker response time to changing target poses of the object, as impending changes can be detected before giving rise to noticeable changes in the measured object pose.

In an embodiment, the vessel is an offshore construction ship with a deck supporting a monopile. The monopile has an elongated shape along a pile centreline and defines an opening at a distal pile end. The monopile may initially rest with its pile centreline along the deck. In this case, hoisting arrangement may for instance include a crane and the object may be an upending tool that is suspended from the crane. This upending tool may be configured to engage and latch on to the opening of the monopile (i.e. “stabbing”), to allow the crane to lift the monopile from the deck (i.e. “upending”). The system may thus be configured to compensate motion of the upending tool while the upending tool approaches and engages the opening of the monopile.

The proposed method allows reliable stabbing operations at significant sea-states, without risking uncontrolled motions or damage to the stabbing tool or pile, and without requiring bulky deck structures.

In a further embodiment, the monopile initially lies substantially horizontally along the deck such that a sagittal plane of the monopile extends perpendicular from the deck and upwards through the pile centreline. In this case, the system may include at least two winches, which are attached to the vessel at determined positions on opposite lateral sides of the sagittal plane and relative to the target reference frame.

In further embodiments, the upending tool may be suspended from the hoisting arrangement via a hoist line. The upending tool may define a further sagittal plane that extends from a hoist line attachment point downwards through the upending tool. Here, at least two taglines may be connected at attachment portions on the upending tool that are positioned at opposite lateral sides of the further sagittal plane.

The proposed arrangement of winches and taglines allows an efficient stabilization for the suspended object against swinging motions corresponding to surge and yaw of the object (if two tag-lines are used, and in reference to the directions as described above in vessel 10 coordinates) or corresponding to sway, surge, and yaw motions of the object (if three tag-lines are used). Other combinations of prohibited and partly allowed motions can be chosen, for instance such that sway is allowed to a limited extent whereas yaw, surge and roll of the object are being compensated or yaw, surge and pitch (all, as to be interpreted from a vessel direction point of view).

In further embodiments, the monopile may be arranged sideways across the vessel deck with the pile opening protruding beyond a side of the vessel. The tool may then define a frontal plane that extends through its centre of mass, downwards along a direction corresponding to the gravitational force and sideways parallel to the side of the vessel. The pile opening and the winches may then be located in a half-space on a side of the frontal plane that faces towards the vessel. By contrast, a distal end of the hoisting arrangement, for instance the crane tip, is repositionable to either side of the frontal plane to allow reversing a lateral direction of the offset for the tool.

In embodiments, the winches may include three winches with three corresponding taglines. At least two of the taglines may then be connected at connection portions that are positioned at lower and laterally opposite distal ends of the upending tool. Another one of the taglines may then be connected at a lateral edge of the upending tool.

Such winch and tagline arrangements have been found to be very effective at compensating motion for a suspended upending tool during stabbing of a monopile that is initially arranged in a horizontal position on the deck of a moving vessel. In alternative embodiments, any of the taglines may also be attached to an upper edge or a lower edge of the tool, or to any possible combination of attachment point on the tool.

According to embodiments, at least one of the taglines may include a double-reeved arrangement, where the tagline is connected with one distal end to the corresponding winch, extends to the object and then via a rolling or sliding connection at the attachment portion of the object, and then back to a fixed or releasable connection on the vessel. In this case, the force sensor may be located at or near the fixed or releasable connection. Alternatively, the force sensor may be connected on/in the attachment portion of the object or in the sheave or sliding part.

This double-reeved connection allows the tagline to be easily reached, disconnected, and stored by personnel that is located on deck.

According to embodiments, the pose sensor includes an imaging sensor provided on the vessel. The imaging sensor may be configured to detect one or more features of the observed object (e.g. corners or edges) and/or markers provided on the object and may be configured to measure an indication of the momentary pose of the object relative to the target reference frame.

Optical imaging and photogrammetric techniques for detecting markers provide a robust, flexible, and reliable method for measuring pose. By using removeable markers, a desired marker constellation can be adapted easily to the dimensions of the vessel and tool.

According to a second aspect, and in accordance with advantages and effects described herein above with reference to the first aspect, there is provided a method for compensating motion of an object suspended from a hoisting arrangement, such as a crane. The hoisting arrangement is moveably mounted in/on a moving vessel associated with a target reference frame that is moving relative to a fixed external reference frame. The vessel includes winches with taglines that interconnect a respective winch with a corresponding attachment portion on the object. The method may involve:
measuring a momentary pose of the object relative to the target reference frame;
exerting tensional forces between respective winches and the object via the corresponding taglines, and independently actuating the winches to adjust a length of the corresponding tagline;
calculating a target pose for the object relative to the target reference frame, the target pose including an offset relative to an initial pose for the object suspended from the hoisting arrangement in absence of the taglines, wherein the offset may include non-zero lateral displacements directed along respective taglines and towards corresponding winches that are connected to the vessel, and
dynamically actuating the winches to adjust lengths of the respective taglines to let the object assume and maintain the target pose while the vessel moves relative to the external reference frame, based on an error determined between the target pose and the momentary pose of the object.

Also in this case, the method may involve calculating the target pose in a dynamic fashion, e.g. by producing an updated value for the target pose after having received an updated sensor reading of the momentary actual pose. Again, measuring of the momentary object pose may occur directly with respect to the target reference frame, or alternatively be performed in a fixed (e.g. Earth) reference frame and subsequently be relate to a target reference frame by additionally computed coordinate transformations.

According to an embodiment, the method may include measuring indications of momentary tensile forces in the corresponding taglines. The method may further include dynamically actuating the winches based on the momentary tensile forces as well as on the error between the target pose and the measured pose of the object.

As indicate above, the vessel may be an offshore construction ship with a deck supporting a horizontal monopile with an opening and a pile centreline. The object may then be an upending tool suspended from the hoisting arrangement.

In an embodiment, the upending tool may include two lower-situated stabbing members and pile clamping members. The method may then include controlling the hoisting arrangement and the winches with taglines to:
lowering the tool in the target pose including the offset substantially below the pile thereby positioning the stabbing fingers directly below a radial outer surface of the pile near the pile opening;
hoisting the tool upward, thereby letting the stabbing fingers engage with the lower outer surface;
hoisting and pulling the tool towards the pile, thereby aligning the tool with the pile until the tool and the pile fully abut and the centreline of the tool becomes co-axial with the centreline of the pile, and
actuating the clamping members to rigidly connect the tool to the pile to allow the pile to be lifted from the vessel.

In an embodiment, the monopile protrudes sideways across the vessel deck with the pile opening beyond a side of the vessel. The tool may then define a frontal plane extending through its centre of mass, downwards along a direction corresponding to the gravitational force and sideways parallel to the side of the vessel. The pile opening and the winches may then be located in a half-space on a side of the frontal plane that faces towards the vessel. In this case, the method may further include repositioning a distal end of the hoisting arrangement to either side of the frontal plane, thereby reversing a lateral direction of the offset for the tool.

In a further aspect, there is provided a computer program product configured to provide instructions to carry out the method according to the second aspect, when loaded on a computer arrangement.

Yet a further aspect pertains to a computer readable medium (for instance a non-transitory computer readable medium) comprising the computer program product according to the previous aspect.

### BRIEF DESCRIPTION OF DRAWINGS

Embodiments will now be described, by way of example only, with reference to the accompanying schematic drawings in which corresponding reference symbols indicate corresponding parts. In the drawings, like numerals designate like elements. Multiple instances of an element may each include separate labels appended to the reference number (for instance “39a” and “39b”). The reference number may be used without an appended label (e.g. “39”) to generally refer to an unspecified instance or to all instances of that element.

FIGS. 1a-b schematically show a known pile up-ending operation in an offshore setting;

FIGS. 2a-b schematically show side and front views of an upending tool that may be used in embodiments of the proposed system and method;

FIG. 3 schematically shows a system and method according to embodiments;

FIGS. 4a-b schematically show perspective views with further details of the embodiments from FIG. 3;

FIG. 4c schematically shows a side view of a forces distribution that may occur in the embodiments of FIG. 3;

FIG. 5 shows a flow-chart of a control method, according to an embodiment;

FIGS. 6a-6e schematically show a sequence of object arrangement stages, according to a method embodiment;

FIG. 7 schematically shows a double-reeved tagline connection, as may be used in embodiments of the system and method;

FIGS. 8a-8b schematically show alternative embodiments of the system and method involving three winches and taglines, and

FIG. 9 schematically shows yet another embodiment involving three winches and taglines.

The figures are meant for illustrative purposes only, and do not serve as restriction of the scope or the protection as laid down by the claims.

### DESCRIPTION OF EMBODIMENTS

The following is a description of certain embodiments of the invention, given by way of example only and with reference to the figures.

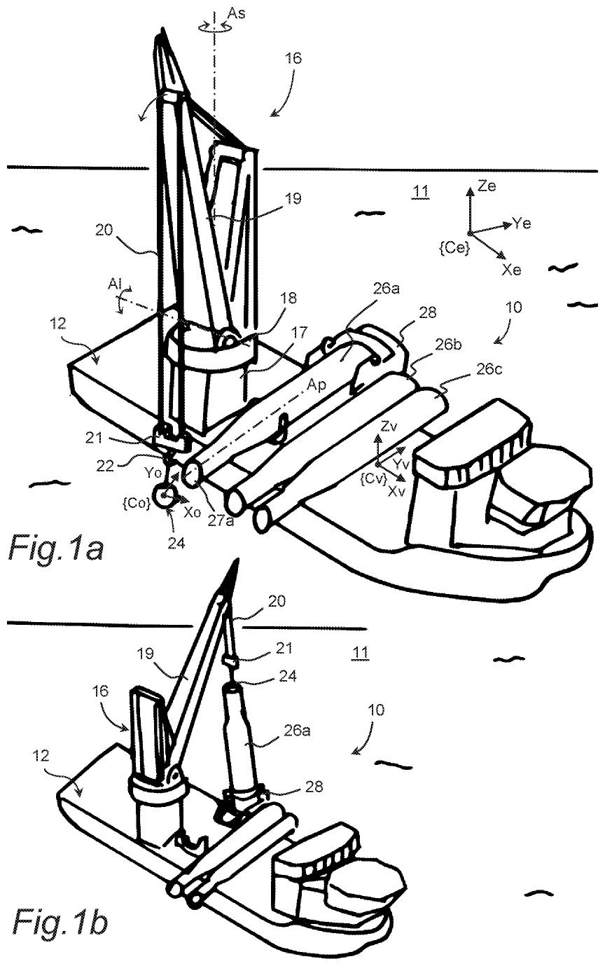

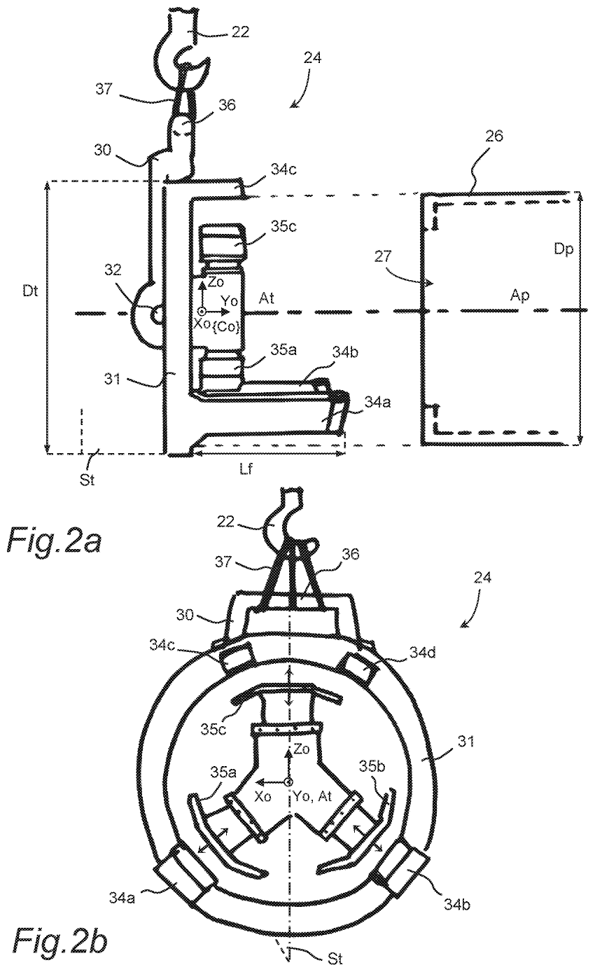

FIGS. 2a-b schematically show a side view and a front view of an exemplary upending tool 24 that may be used in the system and method of the present invention. The upending tool 24 includes a base portion 30 and a stabbing portion 31, which are pivotably interconnected via a hinge 32 to allow the stabbing portion 31 to reposition from a sideways facing position (FIGS. 1a and 2a) to a downwards facing position (FIG. 1b). A characteristic cross-sectional dimension (e.g. diameter) Dt of the tool 24 may be similar to a diameter Dp of the pile 26 to which it needs to be stabbed.

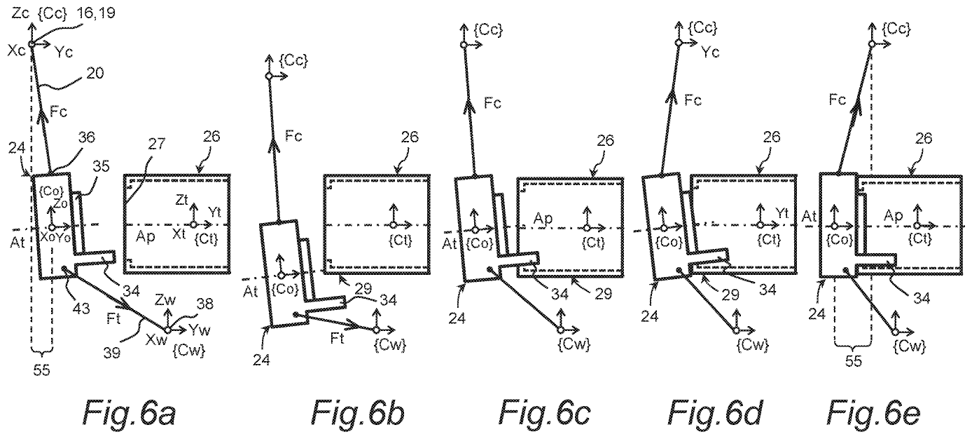

The stabbing portion 31 generally has a shape that matches or can be adjusted to match the round shape of the pile 26 at its upper opening 27. This stabbing portion 31 is centred around a nominal tool centreline At. This centreline At corresponds to a direction in which the tool 24 will approach the opening 27 during the stabbing operation, and which ultimately needs to be aligned with the nominal centreline Ap of the pile 26 (see e.g. FIGS. 6a-6e) within certain tolerances. The upending tool 24 may comprise multiple pile engagement members 34. In the example shown in FIGS. 2a-2b, some engagement members 34 are shaped as lower stabbing fingers 34a-b, which extend in axial directions parallel to the tool centreline At and are adapted to approach and enclose from below a radially outward facing surface of the monopile 26. The exemplary tool 24 has two lower-situated stabbing fingers 34a-b. A (nominal) sagittal plane St divides the stabbing portion 31 of the tool 24 in similar left and right halves, and the lower stabbing fingers 34a-b are preferably arranged in a mirror-symmetric way relative to this sagittal plane St to facilitate aligning with the pile. A length Lf of a lower stabbing finger 34a-b may be in the order of two to four meters or even more. The tool 24 may also include higher-situated stabbing fingers 34c-d for enclosing the outer monopile surface from above, but these further stabbing members 34c-d are preferably small or entirely absent to prevent obstruction when the tool is moved, from a position below the pile opening 27, and upwards towards the outer pile surface 29 (see e.g. FIGS. 6b-c).

The stabbing portion 31 of the tool 24 additionally includes clamping members 35 for temporarily gripping and immobilizing the monopile 26 relative to the tool 24. In the example shown in FIGS. 2a-2b, the clamping members 35 are shaped as clamping surfaces 35 that face radially outwards from the tool centreline At and are initially located within a circumscribed circular boundary that is smaller than the pile opening 27. The stabbing fingers 34 and the clamping surfaces 35 may be moveable relative to each other, to clamp or latch on to the pile 26 once the tool 24 has been inserted. The clamping members 35 may for instance be moveable radially outwards towards corresponding stabbing fingers 34. The stabbing portion 31 may include one or more actuators adapted to move the clamping members 35 radially outward and in a coordinated manner, until surfaces of the clamping members 35 engage a radially inward facing surface of the monopile 26. Typically, the monopile 26 defines a radially inwards flange at its opening 27. Once the clamping members 35 have been extended radially outwards, these members 35 abut an axially inward facing surface of this radial flange when the pile 26 is being lifted.

The base portion 30 of the tool 24 includes a hold-point 36, which is adapted to be rigged to the hook 22 of the crane 16 by means of one or more auxiliary rigging members 37, such as straps or cable loops. The hold-point 36 is preferably located at a vertical position substantially above a centre of mass of the tool 24. This ensures that the tool 24 can be suspended from the crane 16 without skewing or causing inadvertent pivoting of the stabbing portion 31 about the hinge 32. This ensures that the stabbing portion 31 remains facing sideways so that the centreline At and the fingers 32 project sideways in a direction that matches the orientation of the opening 27 and centreline Ap of the horizontal pile 26.

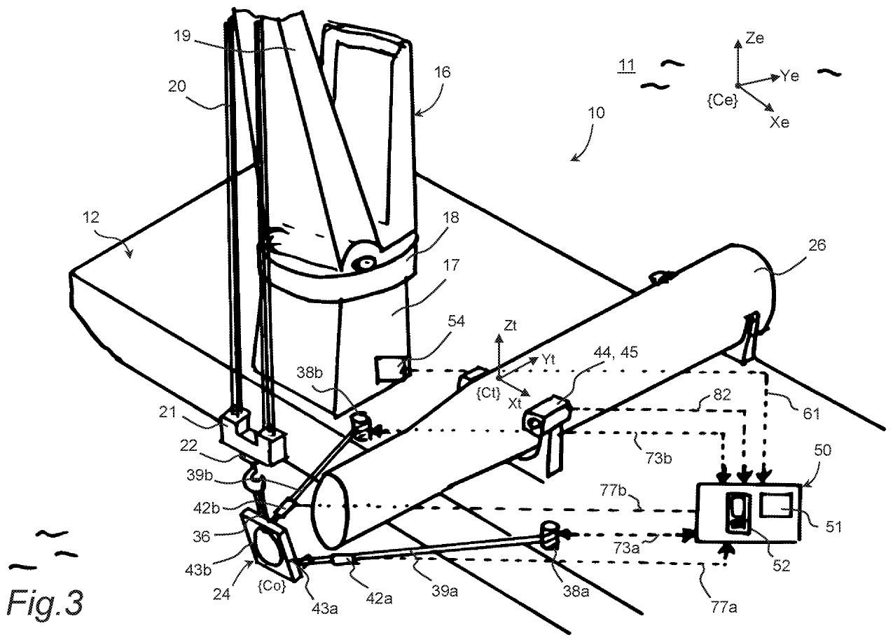

FIG. 3 schematically shows an exemplary embodiment of the proposed system. In this example, the vessel 10 is provided with the hoisting arrangement 16-22 for lifting and moving the upending tool 24 and monopile 26, as discussed previously with reference to FIGS. 1a-1b. Such elements will be considered implicitly present and will not all be discussed here again. The system further includes at least two winches 38a, 38b that are provided at determined locations on the deck 12 of the vessel 10, and at least two corresponding taglines 39a, 39b that interconnect the two winches 38 with associated connection points 43 on the upending tool 24, to provide motion compensation and to facilitate alignment of the upending tool 24 with the monopile 26. In the example of FIG. 3, the two winches 38 are located on deck 12 and are attached to the suspended object 24 via the two taglines 39. These taglines 39 may form single-reeved connections, which each extends from a respective winch 38 straight to a corresponding connection portion 43 where the tagline 39 is fixed to the suspended tool 24.

The system includes two tagline load measuring sensors 42, which are configured to measure an indication of a momentary tensile force acting on/arising in the corresponding tagline 39. This tagline tensile force measurement function may alternatively be provided by measuring the winch motor torque or shaft torque, a load-pin in the winch or in the reeving or any other commonly known means of measuring cable loads (e.g. inside a pulley or a set of pulleys, etc.).

FIG. 3 further illustrates that the exemplary system includes a control device 50, which is in signal connection with the load sensors 42, to receive load measurement signals 77 that indicate a tensile force acting within the respective tagline 39. The control device 50 is further in signal connection with controllers of the winches 38, to allow actuating the winches 38 on an individual basis, such as to independently change the wire length Lt of the corresponding tagline 39. The system further includes a pose sensor 44 for measuring a pose of the suspended upending tool 24 relative to a selected target reference frame {Ct} that is tied to the vessel 10 and for which a spatial relation with the vessel reference frame {Cv} is fixed and known. In this example, the sensor 44 is formed by a photogrammetric camera 45, which is configured to detect at least one optical positioning marker (not shown) provided at one or more determined positions on the tool 24. The camera 45 is configured to acquire (continuously or intermittently) measurement data representative of the actual momentary pose 82 of the tool 24 relative to the target reference frame {Ct}. The camera 45 is in signal communication with the control device 50, to transmit this data (or a portion thereof, possibly involving pre-processing) to the control device 50. Measurements of the momentary pose of the tool 24 may for instance be represented by orthogonal coordinate parameters of the tool reference frame {Co} expressed relative to the target reference frame {Ct} derived from images at specific timestamps.

The control device 50 further takes as input signals of the load measurements in each tagline 39, and the relative positions of the winches 38 i.e. the poses of {Cwa} and {Cwb} with respect to a target reference frame {Cref}, in order to compute the required lengthening or shortening of the taglines 39 needed to adjust the actual tool pose with respect to a desired target pose of the tool 24. This adjusting of the length of the taglines may be effectuated by a rotational position controller of the winches, or by a torque controller of the winches or by a velocity controller of the winches, or any other suitable known mechanism.

In this example, the control device 50 is further in signal connection with a control module 54 of the crane 16, to allow receiving a crane pose 61 and possibly other kinematic or dynamic sensing information. The control device 50 may further incorporate a human machine interface 52, which may allow an operator to enable or disable an anti-sway functionality of the system or to adjust certain parameters during operation.

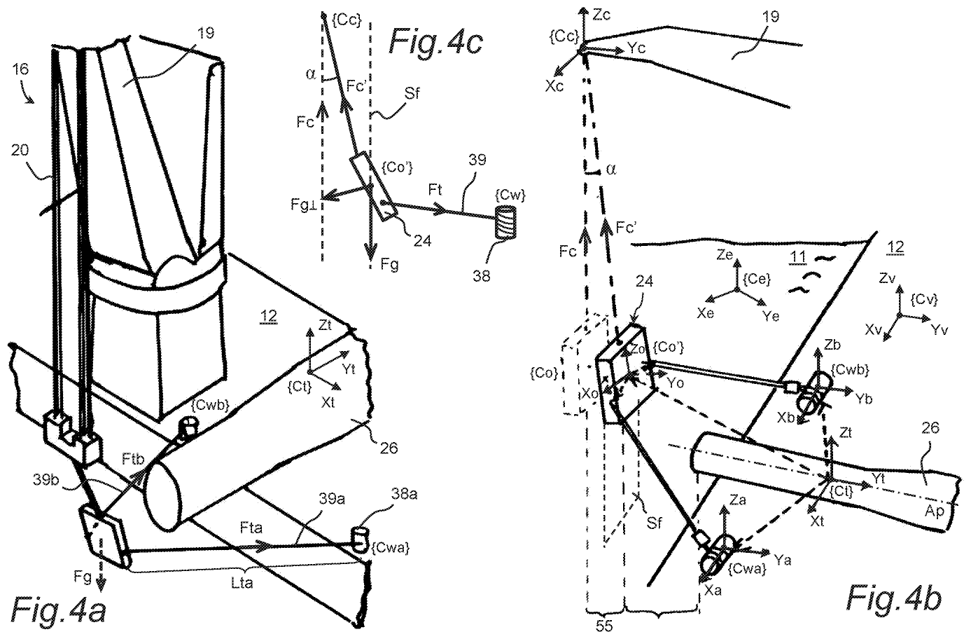

FIGS. 4a-c illustrate an embodiment of the proposed method, in which a net pre-load is generated by a distribution of tension forces Ft exerted by the winches 38 via the taglines 39 on the suspended tool 24. The suspended tool 24 is connected to these winches 38 via the taglines 39, and the positions of the reference frames {Cw} for the winches 38 relative to the target reference system {Ct} are known.

When the tool 24 is suspended from the crane 16 but the taglines 39 are absent, the tool 24 will assume a rest pose corresponding to its local reference frame {Co}, and is subjected to an upwards crane force Fc directed along the hoist line 20 and towards the crane suspension point corresponding to crane reference frame {Cc}, as well as to a gravitational force Fg pointing generally downwards in the fixed external reference system {Ce}. In an equilibrium state with no further forces present, the crane force Fc and gravitational force Fg cancel each other out.

FIGS. 4a-b illustrate a state wherein two taglines 38 are attached to the object 24, and the two corresponding winches 38 are actively controlled to reduce the lengths Lt of the taglines 39, thereby causing the tool 24 to displace away from the rest pose and move closer to the vessel 10 associated with an offset 55. The new pose of the tool 24 and corresponding reference frame is indicated by {Co′}. When viewed down along a negative vertical direction Ze of the external reference frame {Ce}, a vertical projection of the displaced tool location (i.e. the origin of local frame {Co′}) will lie within a projected polygon having projected edges extending between projected vertices of the crane suspension point (i.e. origin of crane frame {Cc}) and the locations of the winches 38 (i.e. the origins of the winch frames {Cw}).

A nominal frontal plane Sf is shown in FIGS. 4b-c, which extends in the-Ze-direction corresponding to the gravity vector Fg through the centre of mass of the tool 24, and extends in the ±Xe-directions parallel to the side of the vessel 10. This frontal plane Sf divides the 3D-space into two half-spaces. In all examples shown in the figures, all of the winches 38 are positioned in the same half-space on the side of the tool 24 and frontal plane Sf that faces towards the vessel 10, whereas the crane tip {Cc} may be repositioned to either side of the frontal plane Sf, depending on the desired direction of pretension and offset 55 for the tool 24 (see e.g. FIGS. 6a-6e).

As shown in FIGS. 4b-c, when the suspended tool 24 moves, the hook 22, the rider block 21 and/or the hoist line 20 of the crane 16 may deflect along with the suspended tool 24, such that the direction and possibly the amplitude of the crane force Fc changes. The updated crane force is denoted Fc′ and oriented along a different direction than the initial Fc. The change in direction may be expressed by an angle α relative to a nominal axis corresponding to the direction of gravity Fg. Provided the length of hoist line 20 is kept constant, the lateral deflection will also result in a (slight) upward displacement of the tool 24, which causes the gravitational potential energy of the tool 24 to be temporarily increased. In addition, the hook 22 and rider block 21 may be supported by additional tug-line winches that may be attached to the turret 18 and/or crane arm 19, to prevent double-pendulation dynamics in the hoisting system.

As shown in FIG. 4c, a portion of the gravity force Fg that is not cancelled by the crane force Fc will give rise to a restitution force component Fg. that acts on the tool 24 in the direction back towards the unperturbed rest pose. In a static equilibrium constellation of the hoist line 20, the taglines 39, the vessel 10 and the crane 16 relative to the external reference frame {Ce}, the various forces Fg, Fc, Ft will cancel each other out, so that the tool 24 remains suspended in the predetermined pose with offset 55. This also implies that the restitution force Fg_{⊥} is to be compensated by the combined opposite force components of the gravitational and taglines forces.

However, any instantaneous change to this equilibrium constellation (i.a. due to a changing direction of Fg gravity or reduction in tagline tension Ft) will allow Fg_{⊥} to exert a restitution force and/or torque (i.e. a wrench) on the tool 24, which will allow the tool 24 to move back outwards in a substantially different direction than would originally be allowed by the tension forces Ft in the directions of the winches 38. The term “wrench” (symbol w) is used herein to indicate a joint 6-vector representation of the net 3D linear force vector (symbol F) and the net 3D torque vector (symbol M) acting on an object.

By carefully selecting (and possibly dynamically adjusting) the positional offset 55 and by corresponding dynamical adjustment of the tagline tensions Ft in accordance with the proposed system and method, the inability of the taglines 39 to exert pushing forces on the suspended tool 24 can be overcome, and the suspended tool 24 can be caused to move and be compensated for unwanted swinging motions also in different and (at least partially) opposite directions than the directions towards the winches 38.

The control device 50 of the proposed system is configured to (dynamically) calculate a desired pose including (pre- or dynamically calculated) offset 55 for the tool 24 relative to its unperturbed pose and to the crane suspension point {Cc}, so as to create an instantaneous restitution force Fg_{⊥} in a desired direction and to adjust the amplitude and/or direction of this restitution force Fg_{⊥} in time, by coordinating and dynamically adjusting the distinct tensional forces Ft that the winches 38 and taglines 39 exert on the upending tool 24, depending on the momentary position of the crane 16 and tool 24 relative to the vessel 10 and relative to the external reference frame {Ce}.

In one possible approach, the desired offset 55 may be determined offline based on dynamic system simulations e.g. before the system is deployed in a real environment. In the simulation, representative values for the envisioned deployment scenario will be selected for dynamic characteristics of the vessel and the tool (such as mass and moments of inertia) as well as for ambient factors like wind force and wave intensity (e.g. wave heights, periods and spreading factors), to simulate what pose offset 55 will be optimal for a given situation. Preferably, a pose offset 55 is determined such that none of the calculated tensions in the taglines drop below a minimum threshold for a pre-set sea state and during the entire simulation run, which is set to last for a representative number of hours (e.g. 3 hours or more).

It is generally preferred that none of the tagline tensions Ft drops below a certain positive value. For instance, when running a simulation for a typical monopile upending tool, minimum tension values may be in a range of 10 kN to 20 kN, or 20 kN to 50 kN, or even 50 kN to 100 kN. Maximum allowed tensional loads for the taglines present in the actual system may for instance be in a range of 50 kN to 100 kN, or 100 kN to 150 kN or even 150 kN to 300 kN. Depending on the environmental conditions and the system's dynamic parameters, the offset 55 determined via simulations may then be in a range of 20 cm to 400 cm or more, for instance in a range of range of 30 cm to 100 cm (all the above ranges include the endpoints).

In an alternative approach, the determination of the pose offset 55 occurs online i.e. dynamically during deployment of the system in a realistic operational setting, using estimated initialization parameters that have been determined through offline simulations (as above) or based on an educated guess. During online determination of the desired offset 55, the tensions in the taglines may then be continuously monitored, and the desired pose offset may be iteratively increased until it is established that the measured tagline tensions Ft no longer assume a zero value or alternatively that the measured tagline tensions always remain above predetermined threshold values. Depending on the chosen constellation of hoist line and taglines, and on the type and direction of swinging motion that the system should compensate, tensional forces in certain taglines may have different thresholds compared to other taglines.

Note that the desired offset 55 may be a translation, a rotation, or any combination thereof and in any direction. For a typical monopile upending tool, the translational offset may for instance be in a range of 0.3 meter to 4 meter, for instance about 3 metres. And a rotational offset may for instance be in a range of 5° to 45°degrees.

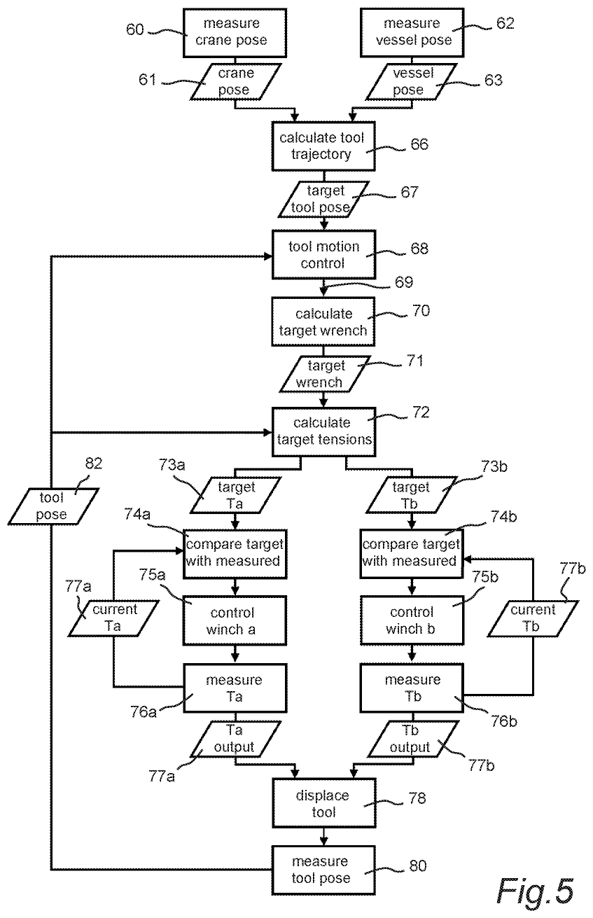

FIG. 5 shows a flow diagram of an exemplary embodiment of the proposed method. The control device 50 of the exemplary system from FIG. 3 is adapted to receive (continuously or intermittently) measurement data from sensors, including the momentary pose of the tool 24 relative to the target reference system {Ct} and the momentary tensional forces Ft exerted by the at least two taglines 39. The control device 50 includes a processing unit 51 configured to calculate the desired pose 67 and offset 55, as well as the required tagline tensions Ft that the control device 50 uses for controlling the winches 38 to dynamically adjust the individual tagline lengths Lt such as to counteract undesired swinging motions of the suspended tool 24. The example in FIG. 5 shows an exemplary method in which tension control branches for only two winches are depicted. It should, however, be understood that other embodiments may involve more than two winches and tension control branches.

The control device 50 is configured to receive data representing the momentary pose 61 or movement of the crane 16 as input from the crane position changing commands issued by the crane control module 54. From this target crane pose 61, and from prevailing external conditions like e.g. the momentary pose 63 of the vessel 10, the control device 50 may derive an unperturbed pose that the suspended tool 24 would assume when subjected to the gravitational pull Fg but in absence of the taglines 39.

The processing unit 51 then calculates 66 a desired target object pose 67 including the lateral offset 55 as compared to the unperturbed pose. Based on this target pose 67, the control device 50 may command its tool motion control module to compare the target pose 67 with a currently measured pose 82 of the tool 24, in order to calculate a pose error metric 69. Based on this error 69, the processing unit 51 calculates a target wrench 71 that is to be applied to the tool 24 to cause the tool 24 to reposition toward the target pose 67. Based on this calculated target wrench 71, the processor unit 51 calculates 72 how the wrench 71 is to be realized by a distribution of tension values Ft in the taglines 39, using a tension distribution algorithm. The separation of the tension values Ft per winch 38 may be determined using analytic matrix equations that may take into account the known positions of tagline attachment points 43 on the tool 24 relative to the tool reference frame {Co}, the measured momentary pose 82 of the tool 24 relative to the target reference frame {Ct}, the known positions {Cw} of the winches 38 on the deck 12 relative to the target reference frame {Ct}, the desired target pose 67 of the tool 24 relative to the target reference frame {Ct} as well as a desired instantaneous pose of the unperturbed tool 24 when suspended under the crane 16 in absence of the taglines.

The control module 50 then sends the respective calculated target tension values 73 to the individual winches 38, thereby commanding each winch 38 to actuate its drive to achieve the newly set target tension 73. Meanwhile, each tension sensor 42 continuously or intermittently samples 76 the momentary tension 77 in the corresponding tagline 39 at subsequent time instances. Each individual winch 38 then compares 74 its currently measured tension force 77 and determines a momentary error between the target force 73 and actual force 77, to determine whether the winch drive needs to continue changing the tagline length Lt or whether the setpoint has been reached. As indicated above, alternative method embodiments may involve tension control branches 73-77 for third, fourth, or even more distinct winches.

The cable tensions Ft generated by the winches 38 finally act on the tool 24, via the taglines 39 and at the positions of the attachment portions 43 on the tool. These tensions exert (linear) forces and (angular) torques on the tool 24, causing it to change pose 78.

Step 80 indicates the continuous or intermittent measurement of the momentary pose 82 of the tool 24 in the target reference frame {Ct}, which may for instance be measured by the camera 45 viewing the marker(s) on the tool. According to the iterative active feedback procedure shown in FIG. 5, this measured tool pose 82 is used when determining the pose error 69 in step 68, and also as partial input parameters for the calculation of the distribution of target tensions in step 72.

FIG. 5 thus illustrates that the proposed method may involve a hierarchy of active feedback control loops, with the tension feedback control loops for the individual tagline sensors being nested inside the pose feedback control loop for the tool motion control 68.

In alternative embodiments, each winch may also make use of a position or velocity control that is set to threshold on determined tension values.

Alternatively or in addition, the control device 50 may optionally be switched into a manual mode by a supervisory controller function that may be activated via the operator interface 52.

FIGS. 6a-6e shows an exemplary sequence of motions during stabbing of a pile 26, according to an embodiment of the method and using an upending tool 24 with lower stabbing fingers 34a-b as shown in FIGS. 2a-b. In a preliminary stage, an operator of the crane 16 may position the suspended tool 24 in the vicinity of a horizontal pile 26, so that the tool 24 and the winches 38 can be interconnected using the taglines 39 (e.g. by another operator or crew member).

FIG. 6a shows an initial course alignment stage, in which preloads are applied via the taglines 39 and the hoist line 20, such that the tool 24 assumes a pose offset 55 along its positive Xo- and Yo-directions, thereby being slightly tilted backwards about its Xo-axis, as compared to its unperturbed pose in absence of the taglines 39.

FIG. 6b shows a subsequent pre-alignment stage, in which the suspended tool 24 with pose offset is lowered relative to the pile 26 by extending the hoist line 20 of the crane 16. The tool 24 is thereby suspended substantially beneath the pile 26, to position the stabbing fingers 34 directly below the radial outer surface 29 of the pile 26 near the opening 27, but without engaging the pile 26. The tool 24 remains in the backwards tilted offset pose 55, to compensate for possible swinging motions.

FIG. 6c shows a subsequent self-alignment stage, in which the tool 24 is hoisted upwards by retracting the hoist line 20, so that the stabbing fingers 34 will contact the lower outer surface 29 of the pile 26. Provided that the stabbing fingers 34 are arranged in a mirror-symmetrical way on the lower part of the tool 24 (relative to the sagittal plane St, see FIG. 2b), the tool 24 will automatically self-align with the pile's lower outer surface 29, and the centreline At of the tool 24 moves towards the centreline Ap of the pile 26.

FIG. 6d shows a further stage, in which the crane 16 changes direction of its preload contribution Fc, by moving the tip of the crane 16 horizontally in a positive Yt-direction towards the pile 26, so that the lower part of the suspended tool 24 directly abuts a lower rim of the pile 26 near its lower outer surface 29.

FIG. 6e shows a final stabbing stage, in which the crane pre-load contribution Fc in the +Yt-direction is increased, such that the tool 24 rotates and aligns with the pile's upper end and that centrelines Ap and At become substantially co-axial. In this pose, the clamping members 35 of the tool 24 have passed through the pile opening 27 and can now be actuated and moved radially outwards to fulfil the pile clamping function (FIG. 2b).

During all the steps shown above, the control device 50 (dynamically) determines the intended target pose including the offset 55, which in the example of FIGS. 6a-6e is dynamically being changed.

The examples in FIGS. 3-4c involve tagline 39 connections between the attachment points 43 on the tool 24 and the winches 38 on the deck 12 which are of a single-reeved kind. In alternative embodiments, however, it is possible that individual ones or all of the tagline connections are multiple-reeved. Such a multiple-reeved tagline is arranged to form one or several loops, starting from the corresponding winch 38 on the vessel 10, via the corresponding attachment point 43 on the suspended object 24, and then back to a sheave or further attachment point on the vessel 10. In alternative embodiments, the tagline may also continue towards an attachment point that is fixed relative to a different target reference frame, such as the fixed external frame {Ce}.

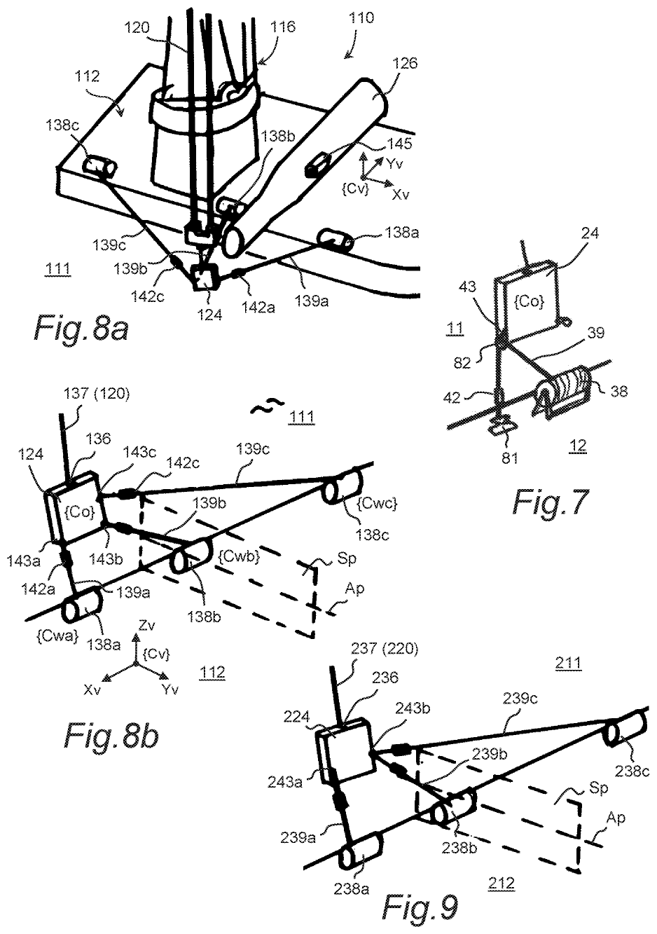

FIG. 7 illustrates an example, which involves a double-reeved tagline connection. In this case, the tagline 39 is wound with one distal end around the winch 38 and is provided at its opposite distal end with the load measurement sensor 42. This distal end is fixed to a connection point 81 that is also located at or near the vessel deck 12. The attachment portion 43 on the tool 24 includes a freely rotatable sheave 82 that allows the tagline 39 to be guided with no or minimal friction along the attachment point 43. This ensures that the tagline connection 43 remains at the same position relative to the object reference frame {Co}, when the tagline 39 is extended or retracted by the rotating winch 38. This double-reeved connection allows the tagline 39 to be easily reached and disconnected from the deck 12. In this concept, the tagline may be composed of two serially connected lines, of which one is permanently fixed to the winch and the other is looped through the attachment point and may be detached from the line that is permanently fixed on the winch. Such connection may be added to ease manual operation on deck by human operators.

In preferred embodiments, the system includes at least three taglines that are attached to the suspended object via at least three winches. Each tagline includes a dedicated tension force sensor.

FIGS. 8a-b show an exemplary embodiment in which three winches 138a-c and corresponding taglines 139a-c and tension sensors 142a-c are provided. The three winches 138 are placed with their respective local reference frames {Cw} in a substantially horizontal and linear arrangement along the deck 112 near the side of the vessel 110. The first winch 138a is positioned at a small distance in negative Zv-direction below the centreline Ap of the pile (not shown) and at a larger distance in positive Xv-direction relative to a sagittal plane Sp of the pile. This sagittal plane Sp is substantially perpendicular to the deck 112 and extends vertically through the pile centreline Ap. The corresponding first tagline 139a is connected to the tool 124 at a first connection portion 143a at a proximal lower corner of the tool body. The second winch 138b is positioned directly below the pile centreline Ap. The corresponding second tagline 139b is connected to the tool 124 at a second connection portion 143b at the opposite lower corner of the tool body. The third winch 138c is positioned at a largest distance in negative Xv-direction from the sagittal plane Sp of the pile. The corresponding third tagline 139c makes an acute angle with the vessel side. This tagline 139c is connected to the tool 124 at a third connection portion 143c that is above the second connection portion 143b but halfway along the lateral edge of the tool body.

FIG. 9 shows yet another exemplary embodiment with a tagline constellation, which makes efficient use of only two connection portions that are symmetrically arranged in a lateral dimension of the tool 224. Here, the winches 238a-c are positioned similar as in FIGS. 8a-b. However, the corresponding first tagline 239a is now connected to the tool 224 at a first connection portion 243a which is at a lower part of a first lateral edge of the tool body. By contrast, the second and third taglines 239b-c are jointly connected to the tool 124 at a second connection portion 243b that is at the same height but on the opposite lateral edge of the tool body.

By optimization and experience, the tagline arrangements in FIGS. 8a-9 have been found to be very effective at compensating motion for a suspended upending tool during stabbing of a horizontal monopile on deck. It should be clear that, in general, many other configurations than the ones shown in the figures may be selected to achieve substantial minimization of undesired swinging motion of the suspended tool. The constellation of winches and taglines may be tailored to improve damping efficacy of a specific subset of undesired motions. It may for instance be desirable to place either one or both of the first or third winches at the largest possible distances in the positive and negative Xv-directions along the vessel side, as is permitted by the length of the vessel. Alternatively, one or more protruding structures may be attached to the vessel, which project laterally outwards from the vessel side and provide remote deployment sites for winches with corresponding taglines that connect to the tool longitudinal directions that are (almost) parallel with the +Xv or −Xv directions. Protruding structures may similarly be provided for additional winches and taglines that connect the tool to remote Zv-locations, for instance a winch in the crane or in the crane turret. Alternatively or in addition, the taglines may be connected to the tool along an upper and/or lower edge thereof, or any other suitable position.

The present invention may be embodied in other specific forms. The described embodiments are to be considered in all respects only as illustrative and not restrictive. The scope of the invention is, therefore, indicated by the appended claims rather than by the foregoing description. It will be apparent to the person skilled in the art that alternative embodiments of the invention can be conceived and reduced to practice. All changes which come within the meaning and range of equivalency of the claims are to be embraced within their scope, to the extent permitted by national law.

In the examples discussed with reference to the figures, the suspended object is formed by an upending tool and the vessel was an offshore construction ship. However, the proposed system and method may also be used when stabilizing swinging motions for other types of objects which are suspended from other types of vessels or platforms that are continuously subjected to undesired surge/sway/heave/roll/pitch/yaw motions relative to a fixed external reference frame. An example of another object is a pile driving hammer, which needs to be accurately placed on top of the pile once the pile has been positioned with its lower end on the seafloor.

In the examples discussed with reference to the figures, the winches and corresponding taglines connections were attached along the vessel deck near the side of the vessel. The winches may be mounted in a repositionable manner at or on the vessel, so that their positions can be adjusted depending on the desired location and operation with the suspended tool. Each winch may for instance be mounted on a local platform (e.g. a cart or track) that is moveable in transversal Xv/Yv-directions along the deck of the vessel, to allow optimizing the effective workspace on the fly. In such cases, the method may involve an additional measurement stage in which the locations of the winch reference frames {Cw} are initially or intermittently determined, to be useable as input parameters in the motion compensation method for the suspended tool.

In the examples, the winches and corresponding taglines connections were generally distributed along a horizontal plane corresponding with the vessel deck. However, by attaching a plurality of taglines above or below the plane, the proposed system and method may create a resulting net restitution force in any direction required to suppress a swinging motion. The principle shown e.g. in FIGS. 4a-c as applied to an Ye-axis relative to a fixed external reference frame {Ce} can also be applied along the Xe- and/or Ze-axes of the external reference frame {Ce}. The only requirement is that the winches are positioned in a constellation that allows the corresponding tagline tensional forces to form an independent (although not necessarily orthogonal) vector basis for the solution space (i.e. degrees of freedom) of the motion compensation algorithm.

In the examples, the pose of the suspended tool was measured remotely by one or more cameras. In alternative embodiments, other types of remote imaging sensors or ranging sensors (e.g. LIDAR) may be used to measure indications of the momentary 6DOF pose of the suspended object relative to the target reference frame. In yet other alternative embodiments, the pose measurements may involve in-situ measurements, for instance by a positioning unit (e.g. a GPS and INS on the vessel) and an internal measurement unit (IMU) attached to the object. In such cases, measurements may be performed in an earth reference frame {Ce} also directly, and then later related to a target reference frame {Ct} by additional computations inside the control unit 50.

Apart from this, those of skill in the art would understand that information and signals may be represented using any of a variety of different technologies and techniques. Those of skill would further appreciate that the various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various illustrative logical blocks, modules, and circuits described in connection with the embodiments disclosed herein, for instance with reference to FIG. 5, may be implemented or performed with a general-purpose processor, a digital signal processor (DSP), an application specific integrated circuit (ASIC), a field programmable gate array (FPGA) or other programmable logic device, discrete gate or transistor logic, discrete hardware components, graphical processor unit (GPU) or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor or a combination of DSP and FPGA, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, solid state disk, removable disk, CD/DVD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

### LIST OF REFERENCE SYMBOLS

Similar reference numbers that have been used in the description to indicate similar elements (but differing only in the hundreds) have been omitted from the list below, but should be considered implicitly included.
10 vessel
11 body of water (e.g. sea)
12 deck
14 vessel side
16 crane (e.g. jib crane)
17 crane pedestal (fixed)
18 crane turret (rotating)
19 crane arm
20 hoist line
21 rider block
22 suspension member (e.g. crane hook)
24 object (e.g. up-end tool; FPUT/FMUT)
26 load (e.g. monopile)
27 pile opening (e.g. with flange)
28 load pivot frame
29 lower outer pile surface
30 base portion
31 stabbing portion
32 hinge
34 engagement member (e.g. stabbing finger)
35 clamping member (e.g. clamp surface)
36 hoisting point
37 auxiliary attachment member (e.g. straps)
38 winch
39 tagline
40 winch sheave with actuator
41 winch controller
42 tagline tension sensor (or winch force/torque sensor)
43 attachment portion
44 pose sensor
45 camera
46 optical markers
50 control device
51 processing unit
52 operator interface
54 crane controller
55 offset
60 control crane pose
61 crane pose command/measurement
62 measure vessel pose
63 vessel pose
64 calculate object trajectory
65 initial (unperturbed) object pose
66 calculate object pose with offset
67 target object pose with offset
68 evaluate offset between target pose and measured pose
69 pose error metric
70 calculate desired wrench on object
71 desired wrench on object
72 calculate tagline tension distribution
73 desired tagline tensile force
74 compare target and measured tensions
75 adjust tension force
76 measure tagline tension force
77 measured tensile force
78 adjust tool pose
80 measure tool pose
80 actual object pose
81 fixed connection
82 sheave
α angle with gravity vector
As slew axis
Al luff axis
Ap monopile centreline
At tool centreline
X first direction
Y second direction
Z third direction
Dp pile diameter
Dt tool diameter
Fg gravity force vector
Fc crane force vector
Fc′ changed crane force vector
Ft/Tt tagline tension
Lf finger length
Lt tagline length
Pt tagline attachment position
Pw winch position
St sagittal tool plane
Sf frontal tool plane
Sp sagittal pile plane
{Co} object reference frame
{Co′} displaced object reference frame
{Cv} vessel reference frame
{Ct} target reference frame
{Cc} crane reference frame
{Ce} fixed external reference frame
{Cw} winch reference frame

1. A system for compensating motion of an object (24) suspended from a hoisting arrangement (16) that is moveably mounted in/on a moving vessel (10) associated with a target reference frame ({Ct}) and moving relative to an external reference frame ({Ce}), the vessel comprising winches (38) with taglines (39) that interconnect a respective winch (38) with a corresponding attachment portion (43) on the object (24) to exert a tensional force (Ft) between the winch and the object, wherein the system comprises:
a pose sensor (44, 45), configured to measure a momentary pose (82) of the object relative to the target reference frame ({Ct});
a control device (50), configured to independently actuate the winches (38) to adjust a length (Lt) of the corresponding tagline (39) to change the tensional force;
wherein the winches (38) are connected to the vessel, and
wherein the control device is further configured to:
calculate (66) a target pose (67) for the object relative to the target reference frame ({Ct}), the target pose including a non-zero offset (55) relative to a pose for the object suspended from the hoisting arrangement in absence of the taglines, and to dynamically actuate (75) the winches to adjust lengths (Lt) of the respective taglines to let the object assume the target pose while the vessel moves, based on an error (69) determined between the target pose and the momentary pose of the object.

2. The system according to claim 1, further comprising force sensors (42) associated with respective taglines (39), each force sensor configured to measure (76) an indication of a momentary tensile force in the corresponding tagline;
wherein the control device (50) is in signal connection with the force sensors, and configured to dynamically actuate the winches (38) based on the momentary tensile force measured by the sensors as well as on the instantaneous error (69) between the target pose and the measured pose of the object.

3. The system according to claim 1 or 2, wherein the vessel (10) is an offshore construction ship with a deck (12) supporting a monopile (26), the monopile being elongated along a pile centreline (Ap) and defining an opening (27) at a distal end, the monopile lying initially with the pile centreline along the deck;
wherein the object is an upending tool (24) suspended from the hoisting arrangement (16), the upending tool being configured to engage and latch on to the opening of the monopile, to allow the hoisting arrangement to lift the monopile from the deck;
and wherein the system is configured to compensate motion of the upending tool (24) while the upending tool approaches and engages the opening of the monopile.

4. The system according to claim 3, wherein the monopile (26) initially lies substantially horizontally along the deck (12) such that a sagittal plane (Sp) of the monopile extends perpendicular from the deck and upwards through the pile centreline (Ap);
and wherein at least two winches (38) are attached to the vessel (10) at determined positions ({Cw}) on opposite lateral sides of the sagittal plane (Sp) and relative to the target reference frame ({Ct}).

5. The system according to claim 3 or 4, wherein the upending tool (24) is suspended from the hoisting arrangement (16) via a hoist line (20), the upending tool defining a further sagittal plane (St) extending from a hoist line attachment point (36) downwards through the upending tool;
and wherein at least two taglines (39) are connected at attachment portions (43) on the upending tool that are positioned at opposite lateral sides of the further sagittal plane (St).

6. The system according to any one of claims 3-5, wherein the monopile (26) protrudes sideways across the vessel deck (12) with the pile opening (27) beyond a side of the vessel, wherein the tool (24) defines a frontal plane (Sf) extending through its centre of mass, downwards along a direction corresponding to the gravitational force (Fg) and sideways parallel to the side of the vessel (10), and wherein the pile opening (27) and the winches (38) are located in a half-space on a side of the frontal plane (Sf) that faces towards the vessel (10), whereas a distal end ({Cc}) of the hoisting arrangement (16) is repositionable to either side of the frontal plane (Sf) to allow reversing a lateral direction of the offset (55) for the tool (24) 7. The system according to any one of claims 1-6, wherein the winches include three winches (138) with three corresponding taglines (139), at least two (139a, 139b) of the taglines being connected at connection portions (143a, 143b) positioned at lower and laterally opposite distal ends of the upending tool (124), and another (139c) of the taglines being connected at a lateral edge (143c) of the upending tool (124).

8. The system according to any one of claims 1-7, wherein at least one of the taglines (39) includes a double-reeved arrangement connected with one distal end to the corresponding winch (38), via a rolling or sliding connection (82) at the attachment portion (43) of the object (24), and then back to a fixed or releasable connection (81) on the vessel (10), optionally wherein the force sensor (42) is located at or near the fixed or releasable connection (81).

9. The system according to any one of claims 1-8, wherein the pose sensor (44) includes an imaging sensor (45) provided on the vessel (12), the imaging sensor being configured to detect one or more markers provided on the object (24) and to measure an indication of the momentary pose (82) of the object relative to the target reference frame ({Ct}).

10. A method for compensating motion of an object (24) suspended from a hoisting arrangement (16) that is moveably mounted in/on a vessel (10) associated with a target reference frame ({Ct}) and moving relative to an external reference frame ({Ce}), the vessel comprising winches (38) with taglines (39) that interconnect a respective winch (38) with a corresponding attachment portion (43) on the object (24), wherein the method comprises:
measuring (80) a pose (82) of the object relative to the target reference frame;
independently actuating (75) the winches (38) to adjust lengths (Lt) of the corresponding taglines (39) to change tensional forces (Ft) exerted (77) between respective winches and the object;
calculating (66) a target pose (67) for the object relative to the target reference frame ({Ct}), the target pose including a non-zero offset (55) relative to a pose for the object suspended from the hoisting arrangement in absence of the taglines, and dynamically actuating (75) the winches to adjust lengths (Lt) of the respective taglines to let the object assume the target pose while the vessel moves, based on an error (69) determined between the target pose and the momentary pose of the object.

11. The method according to claim 10, further comprising:
measuring (76) indications of momentary tensile forces in the corresponding taglines (39), and
dynamically actuating (75) the winches (38) based on the momentary tensile forces as well as on the error (69) between the target pose and the measured pose of the object.

12. The method according to claim 10 or 11, wherein the vessel (10) is an offshore construction ship with a deck (12) supporting a monopile (26), the monopile being elongated along a pile centreline (Ap) and defining an opening (27) at a distal end, the monopile lying initially with the pile centreline along the deck, and the object being an upending tool (24) suspended from the hoisting arrangement (16);
wherein the method further comprises controlling the hoisting arrangement (16) and the winches (38) with taglines (39) to make the upending tool approach and engage the opening of the monopile, while compensating motion of the upending tool (24) by holding the upending tool in the target pose including the offset (55), wherein the offset may include non-zero lateral displacements directed along respective taglines and towards corresponding winches.

13. The method according to claim 12, wherein the upending tool (24) includes to lower-situated stabbing members (34a, 34b) and pile clamping members (35), and wherein the method further comprises controlling the hoisting arrangement (16) and winches (38) with taglines (39) and thereby:
lowering the tool in the target pose including the offset (55) substantially below the pile (26) thereby positioning the stabbing fingers (34) directly below a radial outer surface (29) of the pile (26) near the pile opening (27);
hoisting the tool upward, thereby letting the stabbing fingers (34) engage with the lower outer surface (29);
hoisting and pulling the tool towards the pile, thereby aligning the tool with the pile until the tool and the pile fully abut and the centreline (At) of the tool (24) becomes co-axial with the centreline (Ap) of the pile (26), and
actuating the clamping members (35) to rigidly connect the tool to the pile to allow the pile to be lifted from the vessel (10).

14. The method according to claim 12 or 13, wherein the monopile (26) protrudes sideways across the vessel deck (12) with the pile opening (27) beyond a side of the vessel, wherein the tool (24) defines a frontal plane (Sf) extending through its centre of mass, downwards along a direction corresponding to the gravitational force (Fg) and sideways parallel to the side of the vessel (10), and wherein the pile opening (27) and the winches (38) are located in a half-space on a side of the frontal plane (Sf) that faces towards the vessel (10),
wherein the method further comprises repositioning a distal end ({Cc}) of the hoisting arrangement (16) to either side of the frontal plane (Sf), thereby reversing a lateral direction of the offset (55) for the tool (24).

15. A computer program product configured to provide instructions to carry out a method according to any one of claims 10-14 when loaded on a computer arrangement (50).
